(19) United States
(12) Patent Application Publication
(10) Pub. No.: US 2012/0049565 A1
(43) Pub. Date: Mar. 1, 2012

(54) VEHICLE LID DEVICE

(76) Inventor: Jun SAITO, Okazaki-shi (JP)

(21) Appl. No.: 13/215,754

(22) Filed: Aug. 23, 2011

(30) Foreign Application Priority Data
Aug. 24, 2010 (JP) 2010-187565

(51) Int. Cl. B62D 25/00

(52) U.S. Cl. 296/97.22

(57) ABSTRACT

A vehicle lid device includes supply units which supply energy to a vehicle, openings corresponding to the supply units and provided in an outer surface of the vehicle, lids configured to open or close the respective openings, an opening operation unit configured to open each of the lids, a detecting unit which detects whether each of the lids is open or closed, and an action controller, the action controller controlling the opening action of each of the lids in accordance with the opening operation of the opening operation unit, the action controller forbidding opening actions of the lids other than a first lid when the detecting unit detects that the first lid is open among the lids.

### CROSS-REFERENCE TO RELATED APPLICATIONS

This application is based upon and claims the benefit of priority from prior Japanese Patent Application No. 2010-187565, filed Aug. 24, 2010, the entire contents of which are incorporated herein by reference.

### BACKGROUND OF THE INVENTION

1. Field of the Invention

This invention relates to a vehicle lid device for opening lids provided in a vehicle body.

2. Description of the Related Art

A plug-in hybrid electric vehicle comprises an engine driven by fuel such as gasoline, and an electric motor driven by electricity, and is thus moved by the engine and the electric motor. The plug-in hybrid electric vehicle is provided with a fuel tank for storing fuel supplied to the engine, and a battery for supplying electricity to the electric motor. It is therefore necessary to supply fuel to the fuel tank and to charge the battery by use of an external power supply.

Thus, a charging connector connected to the external power supply and a fuel supply opening for supplying fuel are formed in the plug-in hybrid electric vehicle. The connector and the fuel supply opening are located in recesses which are provided in an outer wall part of a vehicle body and which open outward. One recess is formed for the connector and the fuel supply opening each, and each recess is covered with a lid in an openable/closable manner.

In the plug-in hybrid electric vehicle of this type, a main relay provided between the connector to which the external power supply is connected and the battery is controlled to be switched off when the fuel is supplied to the fuel tank simultaneously with the charging of the battery using the external power supply. At this moment, both the charging lid and the fuel supply lid are open. For example, see Jpn. Pat. Appln. KOKAI Publication No. 2008-290577.

When the lids are opened as in Jpn. pat. Appln. KOKAI Publication No. 2008-290577, any of the lids may be left unclosed. If any of the lids is left unclosed, a driver becomes aware of the unclosed lid when looking in a side-view mirror, and therefore has to take the trouble to go out of the vehicle again.

### BRIEF SUMMARY OF THE INVENTION

According to an aspect of embodiments, a vehicle lid device includes supply units which supply energy to a vehicle; openings corresponding to the supply units and provided in an outer surface of the vehicle; lids configured to open or close the respective openings; an opening operation unit configured to open each of the lids; a detecting unit which detects whether each of the lids is open or closed; and an action controller, the action controller controlling the opening action of each of the lids in accordance with the opening operation of the opening operation unit, the action controller forbidding opening actions of the lids other than a first lid when the detecting unit detects that the first lid is open among the lids.

According to an aspect of embodiments, a vehicle lid device includes two supply units which supply energy to a vehicle; two openings corresponding to the two supply units and provided in an outer surface of the vehicle two lids configured to open or close the respective openings; an opening operation unit configured to open each of the two lids; a detecting unit which detects whether each of the two lids is open or closed; and an action controller, the action controller controlling the opening action of each of the two lids in accordance with the opening operation of the opening operation unit, the action controller forbidding opening action of the lid other than a first lid when the detecting unit detects that the first lid is open among the two lids.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing a hybrid electric vehicle comprising a vehicle lid device according to a first embodiment of the present invention;

FIG. 2 is a flowchart showing the operation of the vehicle lid device shown in FIG. 1;

FIG. 3 is a flowchart showing the operation of the vehicle lid device shown in FIG. 1; and

FIG. 4 is a flowchart showing the operation of a vehicle lid device according to a second embodiment of the present invention.

### DETAILED DESCRIPTION OF THE INVENTION

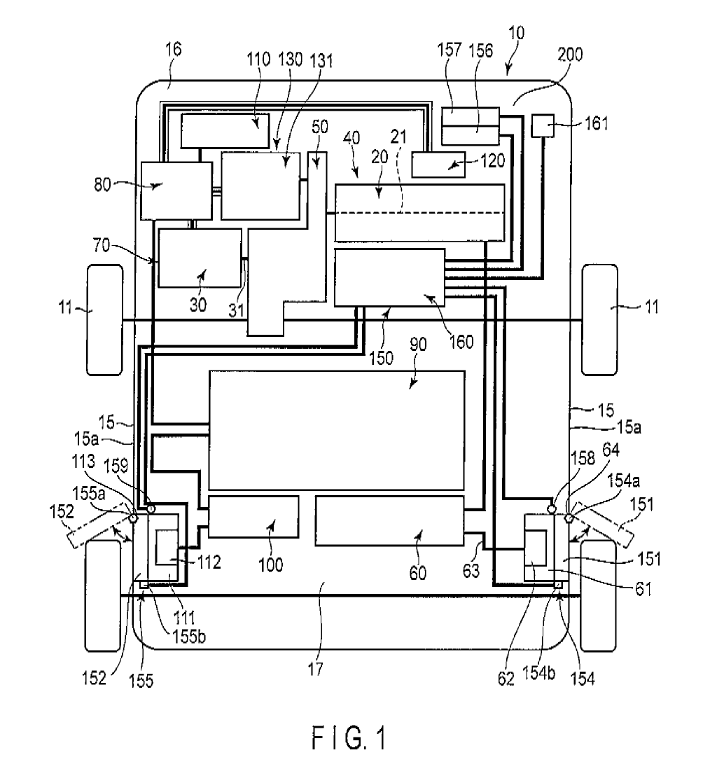

A vehicle lid device according to a first embodiment of the present invention is described with reference to FIG. 1 to FIG. 3. FIG. 1 is a schematic diagram showing a hybrid electric vehicle 10. The hybrid electric vehicle 10 is an example of a vehicle referred to in the present invention.

As shown in FIG. 1, the hybrid electric vehicle 10 comprises a driving engine 20 and a driving electric motor 30. In accordance with a driving condition, the hybrid electric vehicle 10 is driven only by the electric motor 30, driven only by the engine 20, or driven by both the electric motor 30 and the engine 20. The engine 20 is an example of an internal combustion engine referred to in the present invention. The electric motor 30 is an example of a motor referred to in the present invention.

Thus, the hybrid electric vehicle 10 comprises an engine driving system 40 that can be driven by the engine 20, an electric motor driving system 70 that can be driven by the electric motor 30, and a charging system 130.

The engine driving system 40 for driving by the engine 20 is described. The engine driving system 40 comprises the engine 20, a transmission 50, and a fuel tank 60. The engine 20 uses gasoline as an example of a fuel. The fuel tank 60 holds the gasoline.

The engine 20 and the transmission 50 are located in the front part of the vehicle body. The engine 20 is coupled to the transmission 50. The speed of rotation of a crank shaft 21 of the engine 20 is changed by the transmission 50. In the diagram, the crank shaft 21 is indicated by dotted lines. The transmission 50 transmits the rotation of the crank shaft 21 to a pair of front wheels 11, 11. In the present embodiment, the hybrid electric vehicle 10 is a front-wheel-drive vehicle.

A fuel supply recess 61 which opens outward in the vehicle body is formed in an outer wall part 15 that defines the appearance of the hybrid electric vehicle 10. The fuel supply recess 61 is an example of an opening referred to in the present invention. The fuel supply recess 61 opens in an outer surface 15a of the hybrid electric vehicle 10. A fuel supply opening 62 is provided in the fuel supply recess 61. The fuel supply opening 62 is an example of a supply unit referred to in the present invention, and is also an example of a fuel supply unit. The fuel supply opening 62 is coupled to the fuel tank 60 via a fuel pipe 63, and is in communication with the fuel tank 60. The fuel supply opening 62 is removably provided with an inner lid. The fuel supply recess 61 is provided with a later-described fuel supply lid 151 in an openable/closable manner.

The electric motor driving system 70 comprises the electric motor 30, the transmission 50, an inverter 80, a battery 90, and a charger 100. The electric motor 30 is driven by electricity. The inverter 80 and the electric motor 30 are located in a vehicle front part 16. The inverter 80 is electrically connected to the electric motor 30 by a three-phase line. A rotating shaft 31 of the electric motor 30 is coupled to the transmission 50. The transmission 50 changes the speed of rotation of the rotating shaft of the electric motor 30, and then transmits the rotation to the front wheels 11, 11. The transmission 50 is shared by the engine driving system 40 and the electric motor driving system 70.

The battery 90 is electrically connected to the inverter 80, and supplies electricity to the inverter 80. The inverter 80 changes a direct current supplied by the battery 90 to an alternating current, and supplies the alternating current to the electric motor 30. The charger 100 is located in a vehicle body rear part 17. The charger 100 is electrically connected to the battery 90. The charger 100 changes an alternating current supplied by an external power supply to a direct current, and stores the direct current in the battery 90.

The inverter 80 supplies electricity to a 12-V battery 110 which supplies electricity to various accessories provided in the hybrid electric vehicle 10. The inverter 80 also supplies electricity to an air conditioner 120 provided in the hybrid electric vehicle 10.

A charging recess 111 is formed in the outer wall part 15 of the vehicle body. The charging recess 111 is an example of an opening referred to in the present invention. The charging recess 111 is open outward in the vehicle body. The charging recess 111 is open in the outer surface 15a of the outer wall part 15. A connector 112 is provided in the charging recess 111, and the connector 112 is electrically connected to the external power supply via, for example, a cable when the battery 90 is charged. The connector 112 is an example of a supply unit referred to in the present invention, and is also an example of an electricity supply unit. The connector 112 is electrically connected to the charger 100. When the cable is connected to the connector 112, the battery 90 is charged.

The connector 112 is provided with a metal terminal which is electrically connected to the above-mentioned cable. The connector 112 is provided with an inner lid. The inner lid can be opened/closed between a position to expose the terminal and a position to cover the terminal. The charging recess 111 is covered with a later-described charging lid 152 in an openable/closable manner.

The charging system 130 comprises an electric generator 131. The electric generator 131 is located in the vehicle front part 16. The rotating shaft of the electric generator 131 is coupled to the transmission 50. The electric generator 131 is rotated by the transmission of the rotation of the engine 20 to the electric generator 131 via the transmission 50, such that electricity is generated.

The fuel supply recess 61 and the charging recess 111 are covered with lid devices 150 in an openable/closable manner. The lid device 150 is an example of a vehicle lid device as the present invention. The lid device 150 comprises the fuel supply lid 151 which covers the fuel supply recess 61 in an openable/closable manner, the charging lid 152 which covers the charging recess 111 in an openable/closable manner, a fuel supply lid open unit 154 which opens the fuel supply lid 151, a charging lid open unit 155 which opens the charging lid 152, a fuel supply lid open switch 156 which is operated to open the fuel supply lid 151, a charging lid open switch 157 which is operated to open the charging lid 152, a first detector 158 which detects whether the fuel supply lid 151 is open or closed, a second detector 159 which detects whether the charging lid 152 is open or closed, a lid controller 160, and an alarm device 161.

The fuel supply lid open switch 156 is an example of an opening operation unit referred to in the present invention. The charging lid open switch 157 is an example of an opening operation unit referred to in the present invention. The first detector 158 is an example of a detecting unit referred to in the present invention. The second detector 159 is an example of a detecting unit referred to in the present invention. The lid controller 160 is an example of an action controller referred to in the present invention. The alarm device 161 is an example of an informing unit referred to in the present invention.

The fuel supply lid 151 is provided, for example, on an edge 64 of the fuel supply recess 61, and can open or close the aperture of the fuel supply recess 61. The condition in which the fuel supply lid 151 is at an open position is the condition in which the inside of the fuel supply recess 61 is exposed to the outside, so that a fuel supply nozzle can be inserted into the fuel supply opening 62. In FIG. 1, the fuel supply lid 151 at a closed position is shown by a solid line. The fuel supply lid 151 at an open position is shown by a two-dot chain line.

The fuel supply lid open unit 154 has a function for opening the fuel supply lid 151. In the present embodiment, the fuel supply lid 151 is always urged to open by urging means. The urging means is, by way of example, a spring 154a in the present embodiment.

The fuel supply lid open unit 154 comprises the above-mentioned spring 154a and an open unit body 154b. The open unit body 154b can engage with the fuel supply lid 151 to hold the fuel supply lid 151 closed, and can also disengage from the fuel supply lid 151. The open unit body 154b is structured to automatically engage with the fuel supply lid 151 when the fuel supply lid 151 is closed to the end. If the open unit body 154b disengages from the fuel supply lid 151, the fuel supply lid 151 is opened by the urging force of the spring 154a. That is, in the present embodiment, the fuel supply lid open unit 154 comprises, by way of example, the spring 154a and the open unit body 154b.

It should be understood that the structure of the fuel supply lid open unit 154 described above is an example and is not a limitation. For example, the fuel supply lid open unit 154 may have the function to open/close the fuel supply lid 151. In this case, the fuel supply lid 151 does not have to be urged in a direction to open. For example, the fuel supply lid 151 can be opened and closed by an actuator. This actuator serves as the fuel supply lid open unit.

The fuel supply lid open switch 156 is provided in the vicinity of, for example, a driver's seat 200. If the fuel supply lid open switch 156 is operated and turned on, the open unit body 154b of the fuel supply lid open unit 154 is operated to disengage from the fuel supply lid 151 under the control of the later-described lid controller 160.

The first detector 158 detects whether the fuel supply lid 151 is open or closed. In the present embodiment, the first detector 158 contacts the fuel supply lid 151 when the fuel supply lid 151 is closed. When the first detector 158 is in contact with the fuel supply lid 151, the first detector 158 emits a signal. When the fuel supply lid 151 is open, the first detector 158 is out of contact with the fuel supply lid 151 and therefore does not emit any signal.

The charging lid 152 is provided, for example, on an edge 113 of the charging recess 111, and can open or close the aperture of the charging recess 111. The condition in which the charging lid 152 is at an open position is the condition in which the inside of the charging recess 111 is exposed to the outside, so that a charging cable can be connected to the connector 112. In FIG. 1, the charging lid 152 at a closed position is shown by a solid line. The charging lid 152 at an open position is shown by a two⁻dot chain line.

The charging lid open unit 155 has a function for opening the charging lid 152. In the present embodiment, the charging lid 152 is always urged to open by urging means. The urging means is, by way of example, a spring 155a in the present embodiment. The charging lid open unit 155 comprises the above-mentioned spring 155a and an open unit body 155b. The open unit body 155b can engage with the charging lid 152 to hold the charging lid 152 closed, and can also disengage from the charging lid 152. The open unit body 155b is structured to automatically engage with the charging lid 152 when the charging lid 152 is closed. If the open unit body 155b disengages from the charging lid 152, the charging lid 152 is opened by the urging force of the spring 155a. That is, in the present embodiment, the charging lid open unit 155 comprises, by way of example, the open unit body 155b and the spring 155a.

It should be understood that the structure of the charging lid open unit 155 described above is an example and is not a limitation. For example, the charging lid open unit 155 may have the function to open/close the charging lid 152. In this case, the charging lid 152 does not have to be urged in a direction to open. For example, the charging lid 152 can be opened and closed by an actuator. This actuator serves as the charging lid open unit in this case.

The charging lid open switch 157 is provided in the vicinity of, for example, the driver's seat 200. If the charging lid open switch 157 is operated and turned on, the charging lid open unit 155 is operated under the control of the later-described lid controller 160. The condition referred to here in which the charging lid open switch 157 is operated and turned on is an example of the condition in which the lid open switch for opening the lid is operated.

The second detector 159 detects whether the charging lid 152 is open or closed. In the present embodiment, the second detector 159 contacts the charging lid 152 when the charging lid 152 is closed. When the second detector 159 is in contact with the charging lid 152, the second detector 159 emits a signal. When the charging lid 152 is open, the second detector 159 is out of contact with the charging lid 152 and therefore does not emit any signal.

The alarm device 161 informs by generating an alarm sound. In the present embodiment, an audio device originally provided in the hybrid electric vehicle 10 is used as an example of the alarm device 161. Thus, in the present embodiment, the alarm sound is generated as an alarm.

The lid controller 160 is connected to the lid open switches 156 and 157, the open unit bodies 154b and 155b, the first and second detectors 150 and 159, and the alarm device 161. If the lid open switches 156 and 157 are operated, information corresponding to this operation is transmitted to the lid controller 160. Signals emitted by the first and second detectors 158 and 159 are transmitted to the lid controller 160. When the signals are transmitted from the first and second detectors 158 and 159, this signifies that the fuel supply lid 151 and the charging lid 152 are closed. When no signals are sent from the first and second detectors 158 and 159, this signifies that the fuel supply lid 151 and the charging lid 152 are open. In accordance with the information from the lid open switches 156 and 157 and the information from the first and second detectors 158 and 159, the lid controller 160 controls the operations of the lid open units 154 and 155, that is, the operations of the open unit bodies 154b and 155b. If necessary, the alarm device 161 is activated.

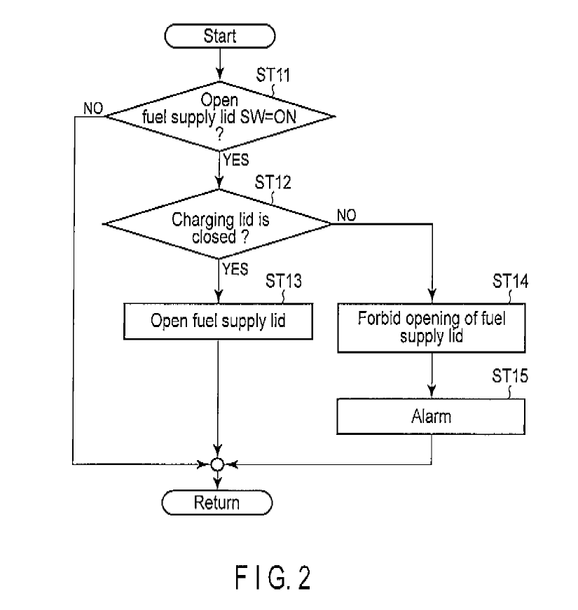

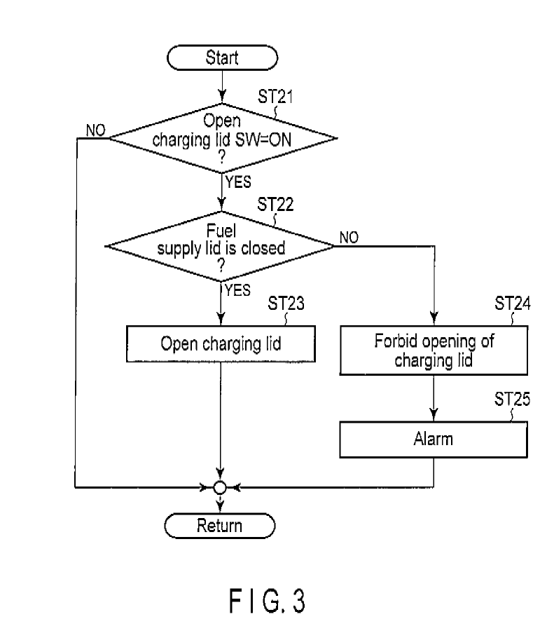

Now, the operation of the lid device 150 is described. FIGS. 2 and 3 are flowcharts showing the operation of the lid device 150. The flowcharts in FIGS. 2 and 3 are put into practice at predetermined intervals.

An example of the operation is described below. It is to be noted that the fuel supply lid 151 and the charging lid 152 are closed. That is, the first and second detectors 158 and 159 send signals to the lid controller 160.

When supplying fuel, an operator operates and turns on the fuel supply lid open switch 156. The operator is, for example, a driver. When the fuel supply lid open switch 156 is on, information indicating this fact is transmitted to the lid controller 160. In step ST11, the lid controller 160 judges whether the fuel supply lid open switch 156 is on. When the operator turns on the fuel supply lid open switch 156, information indicating this fact is transmitted to the lid controller 160, so that the lid controller 160 judges that the fuel supply lid open switch 156 is on. The operation then moves to step ST12.

In step ST12, the lid controller 160 judges whether the charging lid 152 is open. In this condition, the charging lid 152 is closed, so that a signal is emitted from the second detector 159. Thus, the lid controller 160 judges that the charging lid 152 is closed. The operation then moves to step ST13.

In step ST13, the lid controller 160 actuates the open unit body 154b of the fuel supply lid open unit 154 to open the fuel supply lid 151. In response to a disengagement instruction, the open unit body 154b disengages from the fuel supply lid 151. As a result, the fuel supply lid 151 is opened by the urging force of the spring 154a. After the fuel supply lid 151 is opened, the operator removes the inner lid, inserts the fuel supply nozzle into the fuel supply opening 62, and supplies fuel. After the end of the fuel supply, the operator attaches the inner lid, and closes the fuel supply lid 151. When the fuel supply lid 151 is closed, the fuel supply lid 151 engages with the open unit body 154b, and the fuel supply lid 151 is kept closed.

Now, the operation of the lid device 150 is described in connection with an example of the operation for charging the battery 90. It is to be noted that the fuel supply lid 151 and the charging lid 152 are closed. For charging, the operator operates and turns on the charging lid open switch 157. When the charging lid open switch 157 is on, information indicating this fact is transmitted to the lid controller 160. As shown in FIG. 3, in step ST21, the lid controller 160 judges whether the charging lid open switch 157 is on. When the operator turns on the charging lid open switch 157, information indicating this fact is transmitted to the lid controller 160, so that the lid controller 160 judges that the charging lid open switch 157 is on. The operation then moves to step ST22.

In step ST22, the lid controller 160 judges whether the fuel supply lid 151 is open. In this condition, the fuel supply lid 151 is closed, so that a signal is emitted from the first detector 158. Thus, the lid controller 160 judges that the fuel supply lid 151 is closed. The operation then moves to step ST23.

In step ST23, the lid controller 160 actuates the open unit body 155b of the charging lid open unit 155 to open the charging lid 152. In response to a disengagement instruction from the lid controller 160, the open unit body 155b disengages from the charging lid 152. As a result, the charging lid 152 is opened by the urging force of the spring 155a. After the charging lid 152 is opened, the operator removes the inner lid, connects the charging cable to the connector 112, and charges the battery 90. After the end of the charging, the operator attaches the inner lid, and closes the charging lid 152. When the charging lid 152 is closed, the charging lid 152 engages with the open unit body 155b, and the charging lid 152 is kept closed.

Now, the operation of charging during fuel supply is described by way of example in connection with the case in which the charging lid 152 is to be opened when the fuel supply lid 151 is open. In this case, the fuel supply lid 151 is opened in accordance with the flowchart shown in FIG. 2. In this condition, the operator turns on the charging lid open switch 157 for charging. Thus, the operation moves from step ST21 to step ST22 shown in FIG. 3.

In step ST22, the lid controller 160 judges whether the fuel supply lid 151 is open. In this condition, the fuel supply lid 151 is open, so that no signal is transmitted to the lid controller 160 from the first detector 158. Thus, the lid controller 160 judges that the fuel supply lid 151 is open. The operation then moves to step ST24.

In step ST24, in order to keep the charging lid 152 closed, the lid controller 160 does not actuate the charging lid open unit 155. Therefore, the open unit body 155b does not disengage from the charging lid 152, so that the charging lid 152 is not opened. The operation then moves to step ST25.

In step ST25, the lid controller 160 activates the alarm device 161 to notify the operator. As a result, an alarm sound is generated. The operator can recognize by the generated alarm sound that the fuel supply lid 151 is open and fuel is being supplied.

Similarly, the operation of supplying fuel during charging is described by way of example in connection with the case in which the fuel supply lid 151 is to be opened when the charging lid 152 is open. In this case, the charging lid 152 is opened in accordance with the flowchart shown in FIG. 3. In this condition, the operator turns on the fuel supply lid open switch 156 to supply fuel. Thus, the operation moves from step ST11 to step ST12 shown in FIG. 2.

In step ST12, the lid controller 160 judges whether the charging lid 152 is open. In this condition, the charging lid 152 is open, so that no signal is transmitted to the lid controller 160 from the second detector 159. Thus, the lid controller 160 judges that the charging lid 152 is open. The operation then moves to step ST14.

In step ST14, in order to keep the fuel supply lid 151 closed, the lid controller 160 does not actuate the fuel supply lid open unit 154. Therefore, the open unit body 154b does not disengage from the fuel supply lid 151, so that the fuel supply lid 151 is not opened. The operation then moves to step ST15.

In step ST15, the lid controller 160 activates the alarm device 161 to notify the operator. As a result, an alarm sound is generated. The operator can recognize by the generated alarm sound that the charging lid 152 is already open and charging is underway.

Thus, when one of the fuel supply lid 151 and the charging lid 152 is open, the lid controller 160 does not operate the lid open unit of the other lid for disengagement to prevent the other lid from opening even if the open switch for opening the other lid, that is, the charging lid open switch 157 or the fuel supply lid open switch 156 is turned on. It is to be noted that a first lid referred to in the present invention signifies an open lid as described above. That is, the fuel supply lid 151 is the first lid when the fuel supply lid 151 is open, and the charging lid 152 is the first lid when the charging lid 152 is open.

Therefore, the fuel supply lid 151 and the charging lid 152 do not open simultaneously. This inhibits the fuel supply lid 151 and the charging lid 152 from being left unclosed. A concrete explanation is given to this point. When performing charging and fuel supply at the same time, the operator may concentrate on one of the two operations. In this case, if the operator concentrates on one of the operations, for example, the fuel supply, the operator may forget the charging. In this case, the charging lid 152 may be left unclosed.

However, according to the present embodiment, the fuel supply lid 151 and the charging lid 152 do not open simultaneously. That is, as the operator cannot perform charging and fuel supply at the same time, the operator does not forget one of the operations. This makes it possible to inhibit the lid from being left unclosed.

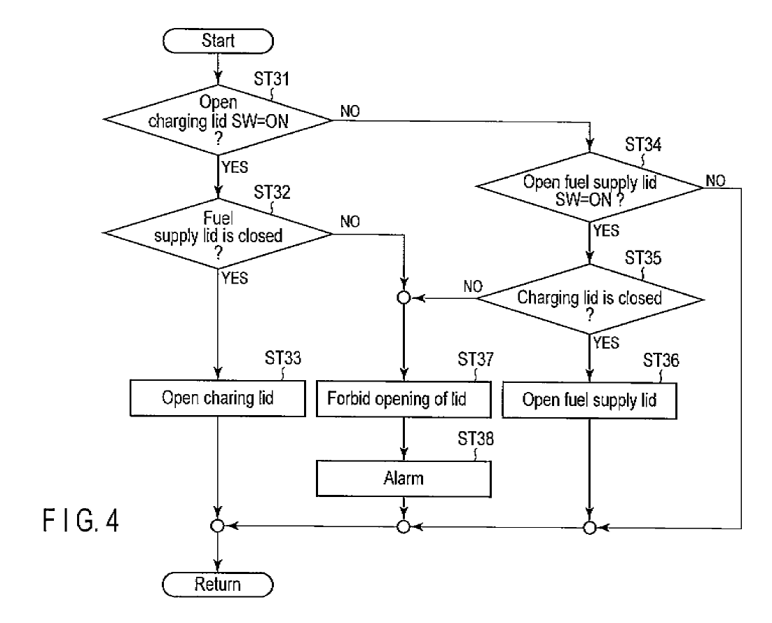

Now, a vehicle lid device according to a second embodiment of the present invention is described with reference to FIG. 4. Components in the second embodiment having functions similar to those in the first embodiment are provided with the same signs and are not described. In the second embodiment, the action of the lid controller 160 is different from that in the first embodiment. The structure is the same as that in the first embodiment in other respects. The difference is specifically described.

FIG. 4 is a flowchart showing the operation of the lid controller 160. The lid controller 160 acts in accordance with the flowchart shown in FIG. 4 instead of the flowcharts shown in FIGS. 2 and 3.

First, the operation for charging is described. It is to be noted that the fuel supply lid 151 and the charging lid 152 are closed. In step ST31, the lid controller 160 judges whether the charging lid open switch 157 is on. When the operator turns on the charging lid open switch 157 for charging, information corresponding to this operation is transmitted to the lid controller 160 from the charging lid open switch 157. Thus, the lid controller 160 judges that the charging lid open switch 157 is on. The operation then moves to step ST32.

In step ST32, the lid controller 160 judges whether the fuel supply lid 151 is closed. In this condition, the fuel supply lid 151 is closed, so that a signal is transmitted to the lid controller 160 from the first detector 158. Thus, the lid controller 160 judges that the fuel supply lid 151 is closed. The operation then moves to step ST33.

In step ST33, the lid controller 160 actuates the open unit body 155b of the charging lid open unit 155 to open the charging lid 152. In response to a disengagement instruction from the lid controller 160, the open unit body 155b disengages from the charging lid 152. As a result, the charging lid 152 is opened by the urging force of the spring 155a. When the charging lid 152 is opened, the operator removes the inner lid of the connector 112, connects the charging cable to the connector 112, and charges the battery 90. After the end of the charging, the operator closes the charging lid 152.

The operation for supplying fuel is described next. It is to be noted that the fuel supply lid 151 and the charging lid 152 are closed. The operation moves from step ST31 to step ST34. In step ST34, the lid controller 160 judges whether the fuel supply lid open switch 156 is on. When the operator turns on the fuel supply lid open switch 156 to supply fuel, information corresponding to this operation is transmitted to the lid controller 160 from the fuel supply lid open switch 156. Thus, the lid controller 160 judges that the fuel supply lid open switch 156 is on. The operation then moves to step ST35.

In step ST35, the lid controller 160 judges whether the charging lid 152 is closed. In this condition, the charging lid 152 is closed, so that a signal is transmitted to the lid controller 160 from the second detector 159. Thus, the lid controller 160 judges that the charging lid 152 is closed. The operation then moves to step ST36.

In step ST36, the lid controller 160 actuates the open unit body 154b of the fuel supply lid open unit 154 to open the fuel supply lid 151. In response to a disengagement instruction from the lid controller 160, the open unit body 154b disengages from the fuel supply lid 151. As a result, the fuel supply lid 151 is opened by the urging force of the spring 154a. When the fuel supply lid 151 is opened, the operator removes the inner lid of the fuel supply opening 62, inserts the fuel supply nozzle into the fuel supply opening 62, and supplies fuel. After the end of the fuel supply, the operator closes the fuel supply lid 151.

The operation for opening the charging lid 152 when the fuel supply lid 151 is open is described next. When the lid controller 160 judges in step ST32 that the fuel supply lid 151 is open, the operation moves to step ST37.

In step ST37, in order to keep the charging lid 152 closed, the lid controller 160 does not operate the charging lid open unit 155 for disengagement. Therefore, the charging lid 152 does not open. The operation then moves to step ST38.

In step ST38, the lid controller 160 activates the alarm device 161 to notify the operator.

The operation for opening the fuel supply lid 151 when the charging lid 152 is open is described next. When the lid controller 160 judges in step ST35 that the charging lid 152 is open, the operation moves to steps ST37 and ST38.

The second embodiment can also provide functions and advantages similar to those in the first embodiment.

In the structures described in the first and second embodiments, two lids, that is, the fuel supply lid 151 and the charging lid 152 are used as an example of lids referred to in the present invention. However, the number of lids is not limited to two. For example, three or four lids may be used instead. In this case as well, a lid open switch as an example of an opening operation unit, a lid open unit, and a detector as an example of a detecting unit for detecting whether the lid is open or closed are provided for each of the lids, as described in the first and second embodiments. Even when one of these lids is open and the lid open switch for opening the other lid is operated, the lid open unit is not operated to open the lid corresponding to this operated lid open switch. That is, there is no condition in which two or more lids are open, functions and advantages similar to those in the first embodiment can be provided.

Furthermore, in the first and second embodiments, the alarm device 161 is used as an informing unit referred to in the present invention. The alarm device has a function for notifying, that is, informing the operator by generating an alarm sound. However, the informing unit is not limited to this The informing unit may be, for example, a lamp and have a function for notifying, that is, informing the operator by light. In short, the informing unit has only to have a function for gaining the operator's attention, that is, informing the operator.

Moreover, the structure described in each of the first and second embodiments comprises the fuel supply lid 151 and the charging lid 152 as the lids. However, the present invention is not limited to this. For example, the lid device 150 may be provided not in the hybrid electric vehicle 10 but in an electric vehicle which is driven by an electric motor alone and which comprises a battery for the electric motor.

The electric vehicle has two kinds of charging means for charging the battery. One of the charging means is, for example, quick charging means that uses a high-voltage power supply. The other charging means is, for example, charging means that uses a household power supply. The electric vehicle is provided with one charging connector used for each of the charging means. That is, the electric vehicle is provided with a total of two connectors. These connectors are similar to the charging connector 112 in the first and second embodiments, and are respectively provided in recesses that are provided in the outer wall part of the vehicle body. Therefore, two recesses are provided. A lid similar to the charging lid 152 is provided in each of these recesses. The recess in the electric vehicle described above is an example of an opening referred to in the present invention.

In the electric vehicle having such a structure as well, the operations of these two lids are controlled as in the first and second embodiments, that is, controlled so that more than one lid may not open, thereby providing functions and advantages similar to those in the first and second embodiments.

While the recess is used as an example of an opening referred to in the present invention in the first and second embodiments, the opening is not limited to the recess.

This invention is not completely limited to the embodiments described above, and modifications of the components can be made at the stage of carrying out the invention without departing from the spirit thereof. Further, various inventions can be formed by properly combining the components disclosed in the embodiments described above. For example, some of all the components shown in the embodiments described above may be eliminated. Moreover, the components in different embodiments may be suitably combined together.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A vehicle lid device comprising:
supply units which supply energy to a vehicle;
openings corresponding to the supply units and provided in an outer surface of the vehicle;
lids configured to open or close the respective openings;
an opening operation unit configured to open each of the lids;
a detecting unit which detects whether each of the lids is open or closed; and
an action controller, the action controller controlling the opening action of each of the lids in accordance with the opening operation of the opening operation unit, the action controller forbidding opening actions of the lids other than a first lid when the detecting unit detects that the first lid is open among the lids.

2. The vehicle lid device according to claim 1, wherein the vehicle is a hybrid vehicle which comprises an internal combustion engine and a battery to supply power to a motor, and
the supply units include a fuel supply unit which supplies fuel to be supplied to the internal combustion engine and an electricity supply unit which supplies electricity to be supplied to the battery.

3. The vehicle lid device according to claim 1, wherein the vehicle comprises an informing unit which informs that the action controller forbids the opening actions.

4. The vehicle lid device according to claim 2, wherein the vehicle comprises an informing unit which informs that the action controller forbids the opening actions.

5. A vehicle lid device comprising:
Two supply units which supply energy to a vehicle;
Two openings corresponding to the two supply units and provided in an outer surface of the vehicle;
Two lids configured to open or close the respective openings;
an opening operation unit configured to open each of the two lids;
a detecting unit which detects whether each of the two lids is open or closed; and
an action controller, the action controller controlling the opening action of each of the two lids in accordance with the opening operation of the opening operation unit, the action controller forbidding opening action of the lid other than a first lid when the detecting unit detects that the first lid is open among the two lids.

6. The vehicle lid device according to claim 5, wherein the vehicle is a hybrid vehicle which comprises an internal combustion engine and a battery to supply power to a motor, and
the two supply units include a fuel supply unit which supplies fuel to be supplied to the internal combustion engine and an electricity supply unit which supplies electricity to be supplied to the battery.

7. The vehicle lid device according to claim 5, wherein the vehicle comprises an informing unit which informs that the action controller forbids the opening actions.

8. The vehicle lid device according to claim 6, wherein the vehicle comprises an informing unit which informs that the action controller forbids the opening actions.
